(19) United States
(12) Patent Application Publication
(10) Pub. No.: US 2003/0101414 A1
(43) Pub. Date: May 29, 2003

(54) Two-layer form-based document generation for multimedia data collection and exchange

(76) Inventors: Peiya Liu, East Brunswick, NJ (US); Liang H. Hsu, West Windsor, NJ (US)

Correspondence Address: Siemens Corporation, Intellectual Property Department, 186 Wood Avenue South, Iselin, NJ, 08830, US

(21) Appl. No.: 10/280,017

(22) Filed: Nov. 28, 2001

(51) Int. Cl. G06F 15/00

(52) U.S. Cl. 715/513

(57) ABSTRACT

There is provided a formed-based document generator for dynamically generating two-layer form documents from two-layer form specifications. A background document generator generates a background document layer having a static data format, from background media and from two-layer form specifications that comprise high-level XML-based specifications. A foreground form overlayer generates a foreground document layer having a dynamic data collecting capability, from the two-layer form specifications. A mixing buffer mixes the background document layer and the foreground document layer to generate a two-layer form document. A data collector collects static and dynamic data for inclusion in the two-layer form document.

### BACKGROUND

1. Technical Field

The present invention generally relates to form-based document generation for multimedia data and, in particular, to two-layer form-based document generation for multimedia data collection, transporting, exchanging, and browsing based on formal document specifications.

2. Background Description

Form-based documents are traditionally designed as one-layer documents. In this type of form, the static information is mixed with dynamic information in one document layer as a normal document. The one-layer form-based document can be designed by various existing proprietary graphic layout design software. The mixed data are in proprietary forms and are often limited to transport to external applications for data exchange. In addition, the form document creation and viewing are often limited by proprietary design tools. Currently, with the open form standards of XML and HTML, form documents can be authored using non-proprietary form formats such as Xform and HTML.

However, the open form standards are limited in their capability to support complex form layout for data collection. For example, the above open form standards are satisfactory primarily when used for designing Q&A (question and answer) types of forms. These types of forms are limited in data collection types (often textual information) and media, particularly graphic type data. Limitations in being able to associate necessary graphics in proper positions have restricted the usage of this type of form.

Accordingly, it would be desirable and highly advantageous to have form-based documents and/or form-based standards that are not limited to transport to external application for data exchange, that are not limited in their creation and viewing by proprietary design tools, and that are not limited in their capability to support complex form layout for data collection.

### SUMMARY OF THE INVENTION

The problems stated above, as well as other related problems of the prior art, are solved by the present invention, which is directed to two-layer form-based document generation for multimedia data collection and exchange.

According to an aspect of the present invention, there is provided a formed-based document generator for dynamically generating two-layer form documents from two-layer form specifications. A background document generator generates a background document layer having a static data format, from background media and from two-layer form specifications that comprise high-level XML-based specifications. A foreground form overlayer generates a foreground document layer having a dynamic data collecting capability, from the two-layer form specifications. A mixing buffer mixes the background document layer and the foreground document layer to generate a two-layer form document. A data collector collects static and dynamic data for inclusion in the two-layer form document.

According to another aspect of the present invention, the high-level XML-based specifications comprised in the two-layer form specifications specify data collection locations, data, data media types, and a digital signature location.

According to yet another aspect of the present invention, the background document generator creates the background document layer to have a capability of setting up contexts for data collection areas.

According to still another aspect of the present invention, the foreground form overlayer creates dynamic data collection locations for collecting data from the two-layer form specifications.

According to yet still another aspect of the present invention, the foreground form overlayer creates dynamic data collection locations for specifying data types.

According to a further aspect of the present invention, the data types include at least one of voice, text, images, and lines.

According to a yet further aspect of the present invention, the form-based document generator further comprises a form data exporter for exporting form data in XML form specifications for data exchange.

According to a still further aspect of the present invention, the background document generator determines whether a media type of the background media is in a predetermined media type, creates an image of the predetermined media type when the media type is not in the predetermined media type, and creates a bottom layer from the predetermined media type.

According to an additional aspect of the present invention, the predetermined media type is portable document format (PDF) or encapsulated postscript (EPS).

According to a further additional aspect of the present invention, the foreground form overlayer determines whether a field type of the two-layer form specifications is in a predetermined native field type, and generates corresponding objects for the foreground document layer depending upon whether the field type is in the predetermined native field type.

According to a still further additional aspect of the present invention, the predetermined native field type is a native PDF field type, and the foreground form overlayer generates PDF annotations objects comprising ink annotation objects when the field type is not the native PDF field type and comprising PDF widget objects when the field type is the native PDF field type.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a computer processing system 100 to which the present invention may be applied according to an illustrative embodiment thereof;

FIG. 2 is a diagram illustrating an overview of a specification-based two-layer form document generation system, according to an illustrative embodiment of the present invention;

FIG. 3 is a diagram illustrating relationships of form appearance and an underlying two-layer form model, according to an illustrative embodiment of the present invention;

FIG. 4 is a diagram illustrating a document type definition (DTD) for a two-layer form specification language and an example two-layer form specification file in XML, according to an illustrative embodiment of the present invention;

FIG. 5 is a diagram illustrating the process of background layer form document generation, according to an illustrative embodiment of the present invention; and

FIG. 6 is a diagram illustrating the process of foreground form overlaying, according to an illustrative embodiment of the present invention.

### DETAILED DESCRIPTION OF PREFERRED EMBODIMENTS

The present invention is directed to two-layer form-based document generation for multimedia data collection and exchange. It is to be appreciated that one of the many advantages of the two-layer form documents of the present invention with respect to the prior art is the separation of static information and dynamic data collecting information to support form presentation adaptability in various document browsing and collection environments.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

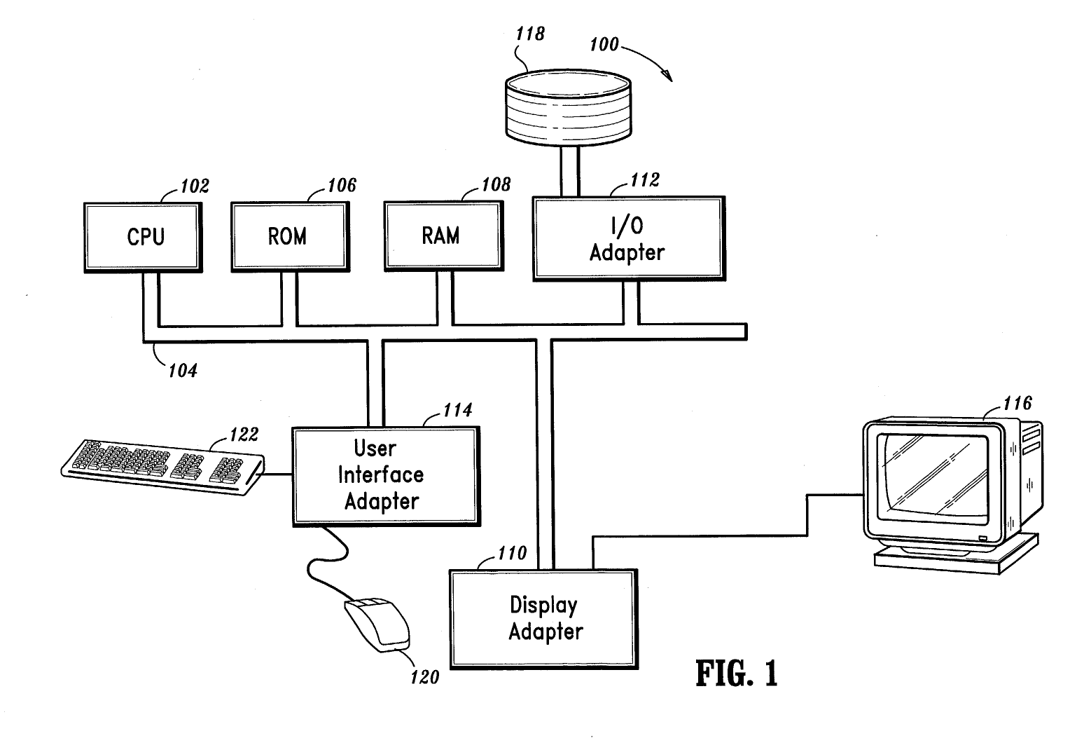

FIG. 1 is a block diagram of a computer processing system 100 to which the present invention may be applied according to an illustrative embodiment thereof. The computer processing system 100 includes at least one processor (CPU) 102 operatively coupled to other components via a system bus 104. A read only memory (ROM) 106, a random access memory (RAM) 108, a display adapter 110, an I/O adapter 112, and a user interface adapter 114 are operatively coupled to the system bus 104.

A display device 116 is operatively coupled to the system bus 104 by the display adapter 110. A disk storage device (e.g., a magnetic or optical disk storage device) 118 is operatively coupled to the system bus 104 by the I/O adapter 112.

A mouse 120 and keyboard 122 are operatively coupled to the system bus 104 by the user interface adapter 114. The mouse 120 and keyboard 122 may be used to input/output information to/from the computer processing system 100.

The present invention provides a two-layer form document generator for dynamically generating form documents on-the fly for multimedia data collection and exchange. The process is based on formal two-layer XML form specifications that are conformed to XML Document-Type Definition (DTD) (1). See, for example, “Extensible Markup Language (XML) 1.0”, W3C Recommendations, Feb. 10, 1998.

The form document specification consists of two parts: a background layer for specifying background printing information and a foreground layer for specifying foreground dynamic data collection information. The form-based document generator transforms document specifications and queries databases and other information repositories to generate structured SGML documents.

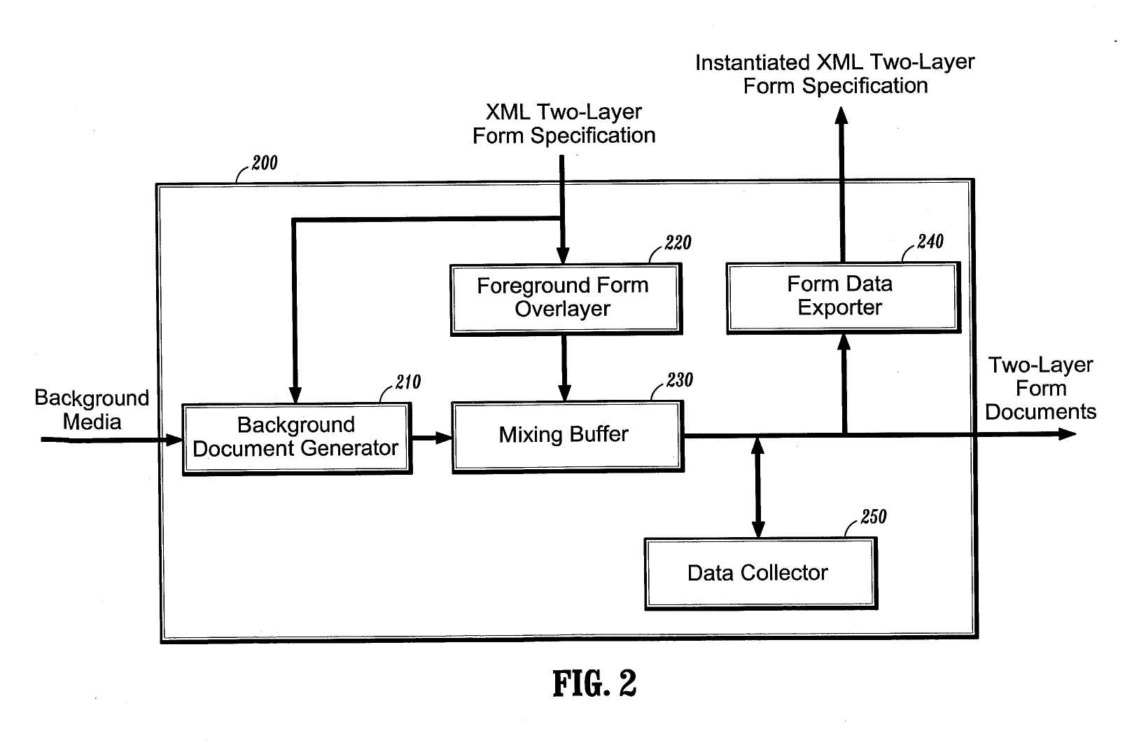

FIG. 2 is a diagram illustrating an overview of a specification-based two-layer form document generation system 200, according to an illustrative embodiment of the present invention. The two-layer form document generation system 200 includes: a background document generator 210; a foreground form overlayer 220; a mixing buffer 230; form data exporter 240; and a data collector 250.

The two-layer form document generation system 200 uses the background document generator 210, the foreground form overlayer 220, the mixing buffer 230, and the data collector 250 to generate two-layer data collection form documents.

The background document generator 210 generates static document information for a background layer of a two-layer form document. This background layer can be considered a background form of the two-layer form document. The background document generator 210 receives XML two-layer form specification and background media as input. The static document information may include, but is not limited to, the following: a static image(s), a drawing(s), a layout(s), and a PDF document(s). It is to be appreciated that the preceding types of static document information are merely illustrative and, thus, other types of static document information may also be employed in accordance with the present invention, while maintaining the spirit and scope thereof.

The foreground form overlayer 220 generates dynamic document information for a foreground layer of a two-layer form document. This foreground layer can be considered a foreground form of the two-layer form document. Moreover, the dynamic document information can be considered as dynamic data collecting information for dynamically collecting data and media for inclusion in a two-layer form document. The foreground form overlayer 220 receives XML two-layer form specification as input. It is to be appreciated that various types of data and media may be specified for data collection in the generation of the dynamic document information for the foreground layer. That is, the present invention is not limited to any particular type of data or media in generating the foreground layer.

The mixing buffer 230 receives outputs of the background document generator 210 and the foreground form overlayer 220 (e.g., background and foreground forms) to generate the two-layer form documents.

Data in the two-layer form documents can be exported by the form data exporter 240 as XML documents (e.g., instantiated XML two-layer form specification) for data exchange in different environments including, but not limited to, the following: on-line books, databases, web sites, files, and so forth. It is to be appreciated that the preceding environments are merely illustrative and, thus, the data in the two-layer form documents can be exported to other environments than those listed above, while maintaining the spirit and scope of the present invention.

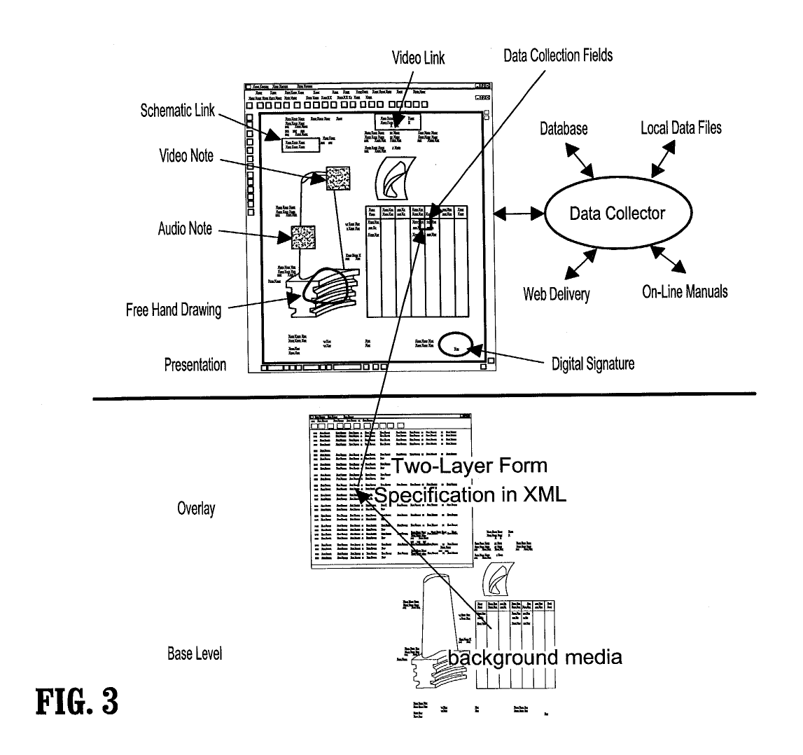

The two-layer form documents can be viewed by the data collector 250. Various other capabilities of the data collector 250 are described below with respect to FIG. 3

FIG. 3 is a diagram illustrating relationships of form appearance and an underlying two-layer form model, according to an illustrative embodiment of the present invention.

Given the relationships illustrated in FIG. 3 of form appearance with respect to the underlying two-layer form model, it is readily apparent to one of ordinary skill in the related art that the data collector 250 has the following capabilities that may be implemented using two-layer form documents generated in accordance with the present invention: free hand writing capability, hyperlinked schematic, video and image for service task explanation in data collection forms; multimedia data collection; and digital signature. Moreover, given the teachings of the present invention provided herein, one of ordinary skill in the related art will contemplate these and various other capabilities of the data collector 250 while maintaining the spirit and scope of the present invention.

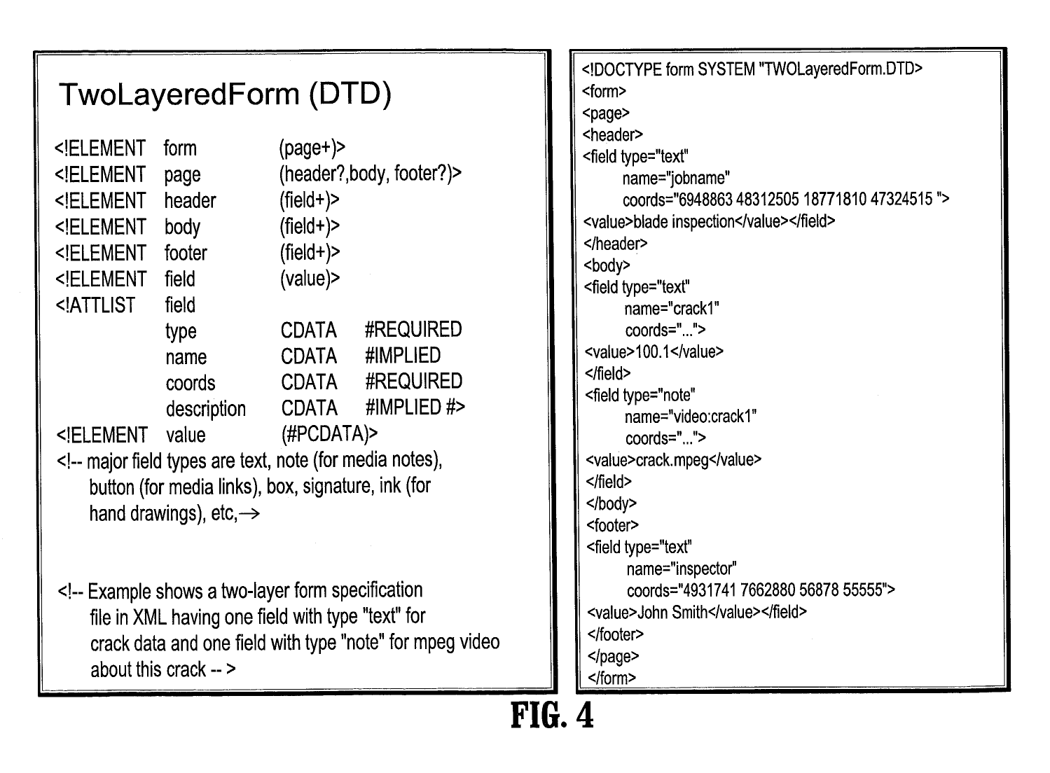

FIG. 4 is a diagram illustrating a document type definition (DTD) for a two-layer form specification language and an example two-layer form specification file in XML, according to an illustrative embodiment of the present invention.

As shown, major field types in the DTD for the two-layer form specification language include text, note (e.g., for media notes), button (e.g., for media links), box, signature, ink (e.g., for hand drawings), and so forth.

Further, the example two-layer form specification file in XML shows a field with type “text” for crack data and another field with type “note” for an MPEG video corresponding to the crack data.

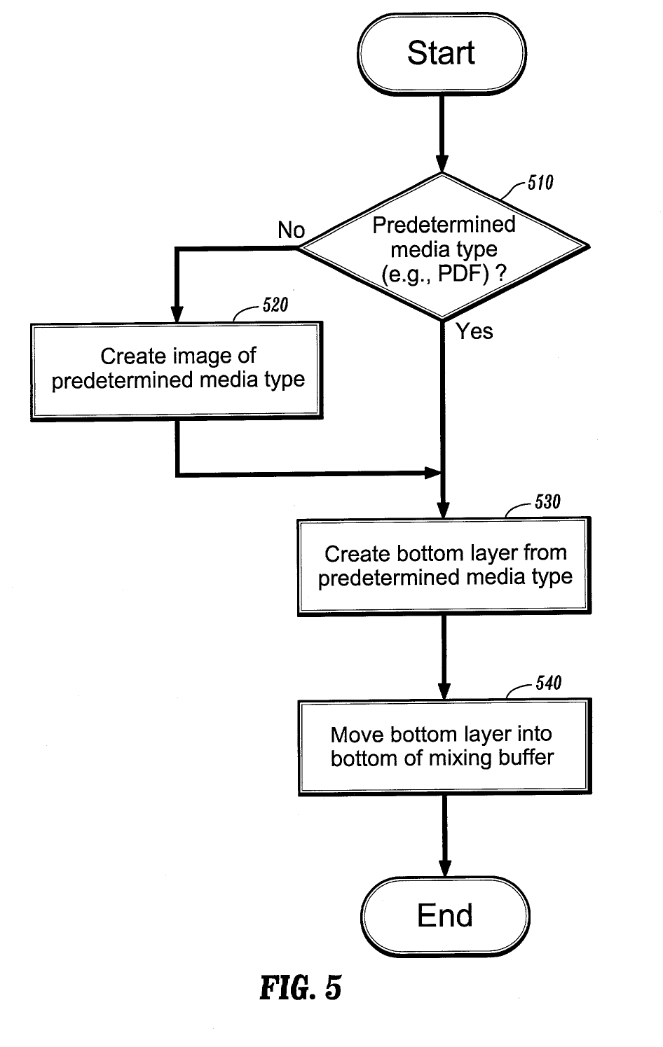

FIG. 5 is a diagram illustrating the process of background layer form document generation, according to an illustrative embodiment of the present invention. The method of FIG. 5 is described with respect to a predetermined media type. In a preferred embodiment of the present invention, the predetermined media type is portable document format (PDF). Accordingly, when the predetermined media type is mentioned with respect to the method of FIG. 5, PDF will immediately follow thereafter in parenthesis. It is to be appreciated that while PDF is described with respect to the predetermined media type, any other media type may also be readily employed by one of ordinary skill in the related art while maintaining the spirit and scope of the present invention.

Upon receiving background media, media type is determined (step 510). That is, it is determined whether the media type is a predetermined media type (PDF). If the media type is not the predetermined media type (PDF), then an image of the predetermined media type (PDF) is created from the other media type (e.g., encapsulated postscript (EPS), graphics interchange format (GIF), tagged image file format (TIF), and so forth, when the predetermined media type is PDF) (step 520), and the method proceeds to step 530. However, if the media type is the predetermined media type (PDF), then the method proceeds to step 530.

At step 530, a bottom layer is created from the predetermined media type (PDF). The bottom layer is then moved into the bottom of the mixing buffer 230 (step 540).

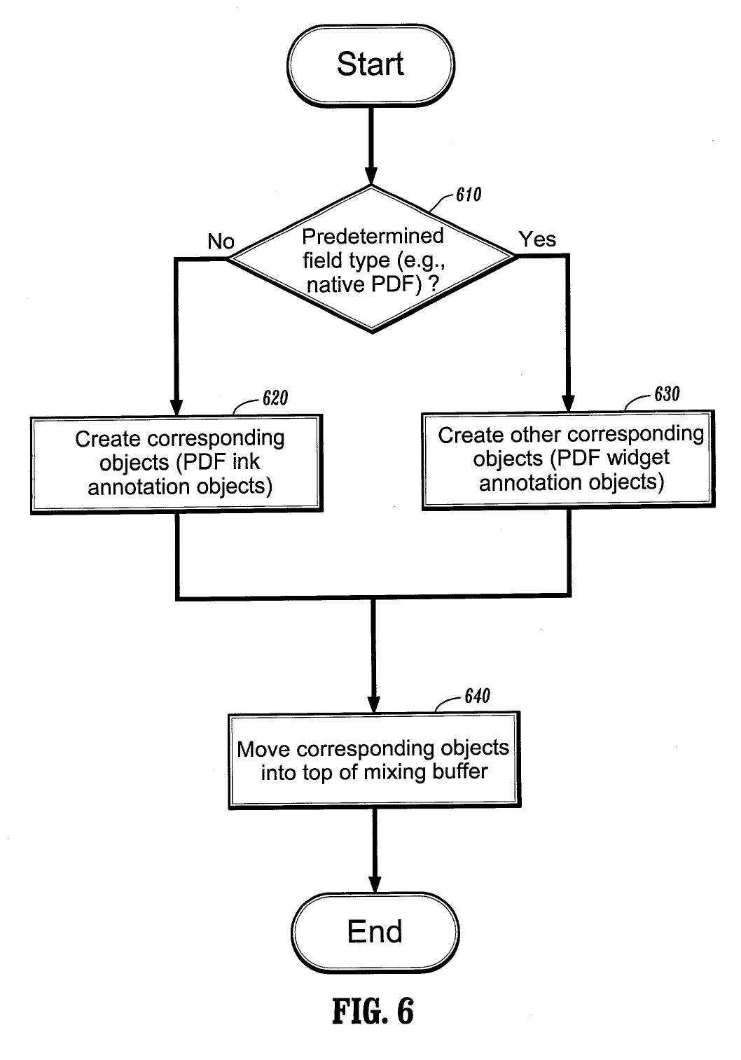

FIG. 6 is a diagram illustrating the process of foreground form overlaying, according to an illustrative embodiment of the present invention. The method of FIG. 6 is described with respect to a predetermined field type. In a preferred embodiment of the present invention, the predetermined field type is native portable document format (native PDF field type). Accordingly, when the predetermined field type is mentioned with respect to the method of FIG. 6, native PDF will immediately follow thereafter in parenthesis. It is to be appreciated that while native PDF is described with respect to the predetermined field type, any other field type may also be readily employed by one of ordinary skill in the related art while maintaining the spirit and scope of the present invention.

Upon receiving two-layer form specifications as input, field type is determined (step 510). That is, it is determined whether the field type is a predetermined native field type (native PDF). If the field type is not the predetermined field type (not native PDF), then corresponding objects (PDF ink annotations) are created (step 520). However, if the field type is the predetermined field type (native PDF), then other corresponding objects (PDF widget annotations) are created (step 530). The corresponding objects (the PDF ink annotations or the PDF widget annotations) are moved into the top of the mixing buffer 230 (step 540).

It is to be appreciated that while orientations (e.g., bottom and top) are described with respect to the mixing buffer, other orientations may be employed with the same device (mixing buffer) or another device(s) that performs the same function, while maintaining the spirit and scope of the present invention.

It is to be further appreciated that form-based documents generated in accordance with the present invention have many applications such as test records for service and maintenance, applications forms in many domains, and so forth. Given the teachings of the present invention provided herein, one of ordinary skill in the related art will contemplate these and various other applications of the two-layer form documents generated in accordance with the present invention, while maintaining the spirit and scope of the present invention. It is to be further appreciated that the two-layer form documents of the present invention provide more versatility for multi-purpose usage of form data in contrast to prior art documents. Thus, in sum, the present invention advantageously automatically generates flexible two-layer form-based documents.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A formed-based document generator for dynamically generating two-layer form documents from two-layer form specifications, the formed-based document generator comprising:
a background document generator for generating a background document layer having a static data format, from background media and from two-layer form specifications that comprise high-level XML-based specifications;
a foreground form overlayer for generating a foreground document layer having a dynamic data collecting capability, from the two-layer form specifications;
a mixing buffer for mixing the background document layer and the foreground document layer to generate a two-layer form document; and
a data collector for collecting static and dynamic data for inclusion in the two-layer form document.

2. The form-based document generator of claim 1, wherein the high-level XML-based specifications comprised in the two-layer form specifications specify data collection locations, data, data media types, and a digital signature location.

3. The form-based document generator of claim 1, wherein said background document generator creates the background document layer to have a capability of setting up contexts for data collection areas.

4. The form-based document generator of claim 1, wherein said foreground form overlayer creates dynamic data collection locations for collecting data from the two-layer form specifications.

5. The form-based document generator of claim 1, wherein said foreground form overlayer creates dynamic data collection locations for specifying data types.

6. The form-based document generator of claim 7, wherein the data types include at least one of voice, text, images, and lines.

7. The form-based document generator of claim 1, further comprising a form data exporter for exporting form data in XML form specifications for data exchange.

8. The form-based document generator of claim 1, wherein said background document generator determines whether a media type of the background media is in a predetermined media type, creates an image of the predetermined media type when the media type is not in the predetermined media type, and creates a bottom layer from the predetermined media type.

9. The form-based document generator of claim 1, wherein the predetermined media type is portable document format (PDF) or encapsulated postscript (EPS).

10. The form-based document generator of claim 8, wherein said foreground form overlayer determines whether a field type of the two-layer form specifications is in a predetermined native field type, and generates corresponding objects for the foreground document layer depending upon whether the field type is in the predetermined native field type.

11. The form-based document generator of claim 10, wherein the predetermined native field type is a native PDF field type, and said foreground form overlayer generates PDF annotations objects comprising ink annotation objects when the field type is not the native PDF field type and comprising PDF widget objects when the field type is the native PDF field type.

12. The form-based document generator of claim 10, wherein said mixing buffer receives the bottom layer and the corresponding objects for the foreground document layer to generate the two-layer form document.

13. The-form-based document generator of claim 1, wherein the data collector has a free hand writing capability with respect to the two-layer form document.

14. The form-based document generator of claim 1, wherein the data collector is capable of generating a hyperlink from the two-layer form document to a corresponding schematic diagram.

15. The form-based document generator of claim 1, wherein the data collector is capable of associating to the two-layer form document a motion video and an image for service task explanation.

16. The form-based document generator of claim 1, wherein the data collector is capable of performing multimedia data collection for the two-layer form document.

17. The form-based document generator of claim 1, wherein the data collector is capable of managing a use of a digital signature on the two-layer form document.

18. The form-based document generator of claim 1, wherein the static and dynamic data are collected from a local data file.

19. The form-based document generator of claim 1, wherein the static and dynamic data are collected from an on-line manual.

20. A method for dynamically generating two-layer form documents from two-layer form specifications, comprising the step of:
generating a background document layer having a static data format, from background media and from two-layer form specifications that comprise high-level XML-based specifications;
generating a foreground document layer having a dynamic data collecting capability, from the two-layer form specifications;
mixing the background document layer and the foreground document layer to generate a two-layer form document; and
collecting static and dynamic data for inclusion in the two-layer form document.

21. The method of claim 20, wherein said method is implemented by a program storage device readable by machine, tangibly embodying a program of instructions executable by the machine to perform said method steps.
